(19) United States
(12) Patent Application Publication
(10) Pub. No.: US 2007/0292691 A1
(43) Pub. Date: Dec. 20, 2007

(54) Compostable reinforced paper, method of making same

(75) Inventors: Shari Chang, Wallingford, CT (US); Irene Jia, Wallingford, CT (US); Ricky Jia, Wallingford, CT (US)

Correspondence Address: BACHMAN & LAPOINTE, P.C., 900 CHAPEL STREET, SUITE 1201, NEW HAVEN, CT, 06510, US

(73) Assignee: C.J. Multi-Tech Enterprises, Inc.

(21) Appl. No.: 11/455,979

(22) Filed: Jun. 19, 2006

(51) Int. Cl. B32B 9/04

(52) U.S. Cl. 428/411.1

(57) ABSTRACT

A composite material includes at least one layer of fibrous material; and at least one biodegradable polymer layer composed of at least one biodegradable polymer, at least one biodegradable copolymer or both at least one biodegradable polymer and at least one biodegradable copolymer. The biodegradable polymer and biodegradable copolymer are each composed of a polymer block selected from the group consisting of poly(alkylene glycol), poly(alkylene oxide), poly(ethylene imine), polyalkylene, polyvinyl, polyvinylether, poly(vinylacetate), polyvinylpyrrolidine, polyester, polylactide, polyglycolide, polycaprolactone, poly(hydroxyalkanoate), poly(meth)acrylates, poly(acrylic acid) and salts thereof, polyether, polyurethane, poly(methacrylic acid) and salts thereof, polyacrylamide, polyepoxide, polyol, polysaccharide, and latex.

### FIELD OF THE INVENTION

The present invention is related to a compostable reinforced paper and, more particularly, relates to a biodegradable coating for use with reinforced paper and methods for applying the same.

### BACKGROUND OF THE INVENTION

Compostable or biodegradable paper, such as the so-called Kraft paper or brown paper, is commonly used for making refuse bags because such brown paper is biodegradable when in compost. The vast majority of cities and towns in America, for example, specifically require that compostable brown paper bags have to be used when a resident bags yard refuse and dumps it for compost.

While relatively strong while dry, brown paper becomes very weak when wetted. The so-called “wet strength” of the brown paper is usually very low and therefore, the use efficiency is limited when the paper becomes moist.

Due to the relatively low “wet strength” of brown paper, thicker, heavier weight paper are typically employed for “heavy duty” uses such as when a large volume material must be bagged. For example, a refuse bag is typically manufactured having a double-ply heavy weight brown paper. These double-layered refuse bags may be durable enough to contain refuse material; however, once these refuse bags become wet their durability weakens considerably. The breakage of these wetted refuse bags occurs even when subjected to mere displacement, let alone any appreciable force.

Therefore, there exists a need for a brown paper having an increased “wet strength” and durability, yet still retaining a biodegradable quality.

### SUMMARY OF THE INVENTION

In accordance with one aspect of the present invention, a composite material broadly comprises at least one layer of fibrous material; and at least one biodegradable polymer layer comprising at least one biodegradable polymer, at least one biodegradable copolymer or both at least one biodegradable polymer and at least one biodegradable copolymer, wherein the biodegradable polymer and the biodegradable copolymer each comprise a polymer block selected from the group consisting poly(alkylene glycol), poly(alkylene oxide), poly(ethylene imine), polyalkylene, polyvinyl, polyvinylether, poly(vinylacetate), polyvinylpyrrolidine, polyester, polylactide, polyglycolide, polycaprolactone, poly(hydroxyalkanoate), poly(meth)acrylates, poly(acrylic acid) and salts thereof, polyether, polyurethane, poly(methacrylic acid) and salts thereof, polyacrylamide, polyepoxide, polyol, polysaccharides, and latex.

In accordance with another aspect of the present invention, a process for manufacturing a composite material broadly comprises formulating an aqueous biodegradable solution having a polymer content of about 0.1% to 50% by weight of said solution; applying the solution to at least one surface of a fibrous material to form at least one biodegradable polymer layer; and drying the at least one biodegradable polymer layer.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a flowchart representing a process of the present invention;

FIG. 2a is a representation of a composite material of the present invention;

FIG. 2b is a representation of another embodiment of the composite material of the present invention;

FIG. 2c is a representation of another embodiment of the composite material of the present invention; and

FIG. 3 is a representation of a piece of test paper used in the tensile-tear break test.

Like reference numbers and designations in the various drawings indicate like elements.

### DETAILED DESCRIPTION OF THE INVENTION

The compostable, reinforced material and method for making the same of the present invention effectively improve the wet strength of brown paper while maintaining both the brown paper's compostability and durability.

The process for manufacturing a composite material, that is, the compostable, reinforced material of the present invention, may comprise creating an aqueous, biodegradable polymer solution at a step 20 of FIG. 1. The aqueous, biodegradable polymer solution may additionally comprise a solvent other than water and a quantity of a biodegradable polymer sufficient to achieve a polymer content of about 0.1% to 50% by weight of the solution. Other suitable solvents that may be included comprise, but are not limited to, alcohol, ether, acetone, alkyl acetate, xylene, any other solvent used as medium during the biodegradable polymer synthesis as known to one of ordinary skill in the art, combinations comprising at least one of the foregoing, and the like. The content of these volatile solvents in the solution, however, is equivalent to or less than about 5%, and preferably zero. The biodegradable polymer solutions as described include not only the conventional solutions based on solute-solvent but the emulsion form(s) as well.

The biodegradable polymer may comprise at least one biodegradable polymer, at least one biodegradable copolymer or both at least one biodegradable polymer and at least one biodegradable copolymer.

A polymer based on the C—C backbone tends to be non-biodegradable, whereas heteroatom-containing polymer backbones confer biodegradability. Biodegradability can therefore be engineered into polymers by the judicious addition of chemical linkages such as anhydride, ester, or amide bonds, among others. The mechanism for degradation is by hydrolysis or enzymatic cleavage resulting in a scission of the polymer backbone. Macroorganisms can eat and, sometimes, digest polymers, and also initiate a mechanical, chemical, or enzymatic aging. It is well known that biodegradable polymers with hydrolyzable chemical bonds can be used for biomedical, pharmaceutical, agricultural, and packaging applications. Polyesters based on polylactide (“PLA”), polyglycolide (“PGA”), polycaprolactone (PCL), and their copolymers are biodegradable polymers. Degradation of these materials is through the hydrolysis of the ester bond from water or moisture and yields the corresponding hydroxy acids. Acrylate and methacrylate polymers possess the ester bonds and are subject to the hydrolysation. Other bio/environmentally degradable polymers include poly(hydroxyalkanoate)s, additional poly(ester)s, poly(ethylene oxide) (“PEO”), and natural polymers, particularly, latex and modified poly(saccharide)s, e.g., starch, cellulose, and chitosan. Paper products contain natural cellulose fibers and they are degradable. Poly(ethylene oxide), PEO, a polymer with the repeat structural unit —CH₂CH₂O—, is known for its attractiveness as a biomaterial and it has biocompatibility, hydrophilicity, and versatility. The simple, water-soluble, linear polymer can be modified by chemical interaction to form water-insoluble but water-swellable hydrogels retaining the desirable properties associated with the ethylene oxide part of the structure. There are many other degradable polymers also suitable for the purposes of this invention. For example, multiblock copolymers of poly(ethylene oxide) and poly(butylene terephthalate) (“PBT”) are also subject to both hydrolysis (via ester bonds) and oxidation (via ether bonds). Degradation rate is influenced by a material's molecular weight and content. Additionally, the copolymer with the highest water uptake degrades most rapidly. Polyvinyl alcohol is also an example of degradable polymer capable of being water swellable and hydrogel forming.

The biodegradable polymer and the biodegradable copolymer may each comprise a polymer block selected from the group consisting of poly(alkylene glycol), e.g., poly(ethylene glycol), poly(alkylene oxide), e.g., poly(ethylene oxide), poly(ethylene imine), polyalkylene, polyvinyl, polyvinylether, poly(vinyl acetate), polyvinylpyrrolidone, polyester, polylactide, polyglycolide, polycaprolactone, poly(hydroxyalkanoate), poly(meth)acrylates, polysaccharides, polyether, polyurethane, poly(acrylic/methacrylic acid) and its salt, polyacrylamide, polyepoxides, polyol and latex.

At a step 22 of FIG. 1, a quantity of the aqueous, biodegradable polymer solution may be applied to at least one surface of a fibrous material to form a biodegradable polymer layer. Suitable application process may include, but are not limited to, brushing, spraying, combinations comprising at least one of the foregoing processes, and the like, and may be performed a manual process, automated process or both processes. Generally, the biodegradable polymer layer may possess the same thickness, or less, than the thickness of the fibrous material being coated. In a preferred mode, the polymer solution may be applied in an amount sufficient to form a layer having a thickness of about 0.1 micron and up to the thickness of the paper being coated, and preferably about 0.1 micron and up to about half of the thickness of the paper material being coated. For the examples shown in Table 1, the reference paper has an average thickness of about 0.144 mm as measured. Therefore, the coated polymer thickness would be up to about 0.15 mm, and preferably is up to about 0.07 mm for the polymer coating thickness in this case. The polymer solution may be applied as often as necessary in order to achieve the desired thickness of the biodegradable polymer layer.

At a step 24 of FIG. 1, the biodegradable polymer layer may be dried. Suitable drying processes may include, but are not limited to, exposure to an environment maintained at room temperature, with or without additional means of promoting the solvent evaporation, such as air blasting, hot-air blowing, and the like, heating (e.g., infrared radiation) at a temperature and for a time sufficient to dry the biodegradable polymer, combinations comprising at least one of the foregoing, and the like.

Optionally, at a step 26 of FIG. 1, the biodegradable polymer solution may be applied as described herein to at least one other surface of the fibrous material to form a second biodegradable polymer layer. The second biodegradable polymer layer, if applied, may be dried as described herein at an optional step 28 of FIG. 1.

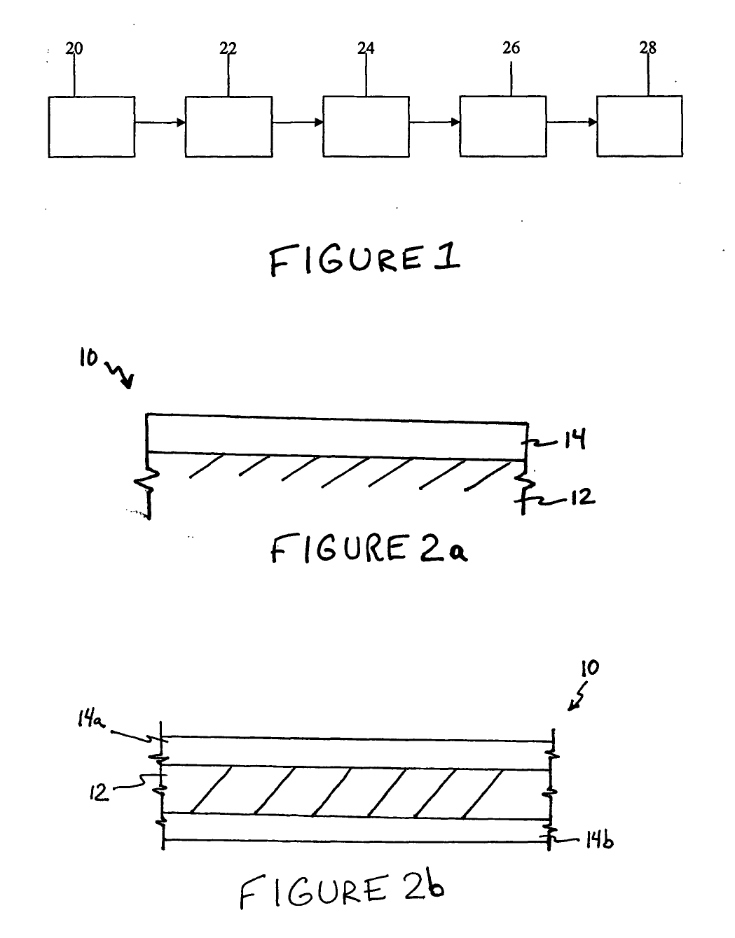

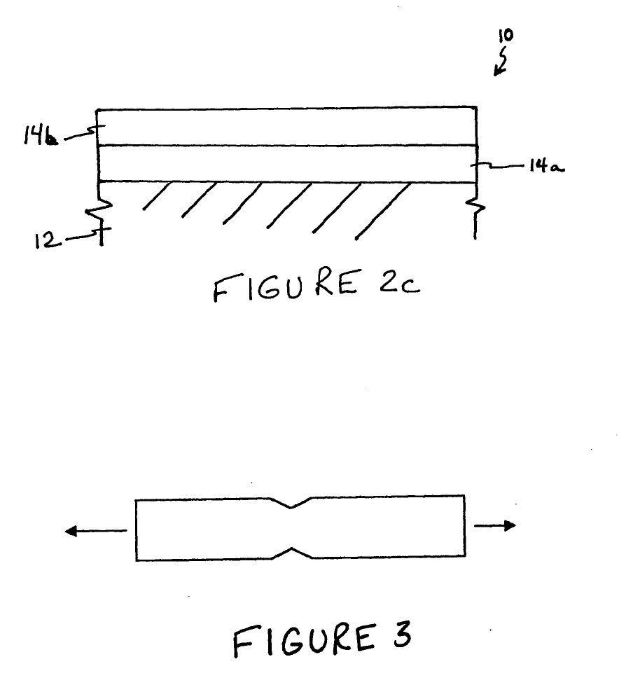

Referring now to FIGS. 2a-2c, a composite material 10 of the present invention may comprise at least one layer of fibrous material 12 and at least one layer of a biodegradable polymer 14 of FIG. 2a or, e.g., layers 14a and 14b of FIG. 2b or layers 14a and 14b of FIG. 2c. The fibrous material may comprise a brown paper. Suitable brown paper may include, but is not limited to, grades A, B, C, D, E, F and G brown paper commercially available as Kraft® paper as known to one of ordinary skill in the art. The biodegradable polymer may comprise at least one biodegradable polymer, at least one biodegradable copolymer or both at least one biodegradable polymer and at least one biodegradable copolymer. The biodegradable polymer and biodegradable copolymer may each comprise a polymer block including, but not limited to poly(alkylene glycol), e.g., poly(ethylene glycol), poly(alkylene oxide), e.g., poly(ethylene oxide), poly(ethylene imine), polyalkylene, polyvinyl, polyvinylether, poly(vinyl acetate), polyvinylpyrrolidone, polyester, polylactide, polyglycolide, polycaprolactone, poly(hydroxyalkanoate), poly(meth)acrylates, polysaccharides, polylactide, polyether, polyurethane, poly(acrylic/methacrylic acid) and its salt, polyacrylamide, polyepoxides, polyol and latex. The layer(s) of biodegradable polymer may possess a thickness of about 0.1 micron to 60 microns, and preferably about 1 micron to 40 microns.

### Experimental Section

Sample Preparation

Twenty-four substrate samples each measuring 16 in.×12 in.×34 in. were prepared from one of eight Duro Bags®, commercially available from Duro Bag Manufacturing Company of Florence, Ky. The twenty-four substrate samples were grouped as follows: Samples A1, A2, A3; B1, B2, B3; C1, C2, C3; D1, D2, D3; E1, E2, E3; F1, F2, F3; and, G1, G2 and G3.

Sample Substrate A 3 was as a reference sample and was not treated.

Sample B 3 was treated on a side a using a 2% by weight PEO solution. The 2% PEO solution was brushed onto the entire surface area of side a to form a coating, and dried.

Sample C 3 was treated on sides a and b using a 2% by weight PEO solution. The 2% PEO solution was brushed onto the entire surface area of side a to form a coating, and dried. The 2% PEO solution was then brushed onto the entire surface area of side b to form a coating, and dried.

Sample D 3 was treated on a side a using a 5% by weight PVA solution. The 5% PVA solution was brushed onto the entire surface area of side a to form a coating, and dried.

Sample E 3 was treated on a side a using a polyacrylic paint aerosol spray. The polyacrylic paint was sprayed onto the entire surface area of side a to form a coating, and dried.

Sample F 3 was treated on a side a using an aqueous latex solution with a latex content of about 45%. The aqueous latex solution was brushed onto the entire surface area of side a to form a coating, and dried.

Sample G 3 was treated on a side a using a 5% by weight PEO solution. The 5% PEO solution was brushed onto the entire surface of side a to form a coating, and dried.

The average measurements and observations for twenty-four substrate samples A(1-3) through G(1-3) are listed below in Table 1. Each substrate sample's thickness was measured 10 times, each time in a random spot, throughout the sample paper within an accuracy of 0.001 millimeters using a Mitutoyo Micrometer, Model 293-301, commercially available from the Mitutoyo-America Corp., Aurora, Ill. The average thickness in millimeters and the standard deviation for each substrate was then calculated. The net polymer coating thickness expressed in micron-meters is the arithmetic difference between the thickness averages of the coated substrate and the uncoated reference paper.

TABLE 1

| | | | Average | Average Net | |
|---|---|---|---|---|---|
| | | | Substrate | polymer | |
| Paper | Polymer | | thickness in | Coating | |
| Substrate | Solution | Treatment | millimeters | thickness* | Visual Observation |
| Codes | identification | process | (S.D.) | (microns) | of substrate surface |
| A | None | None | 0.1440 (0.0063) | none | Reference |
| B | 2% by weight | Brushed | 0.1474 (0.0052) | 3.4 | No recognizable |
| | PEO solution¹ | side a | | | difference |
| C | 2% by weight | Brushed | 0.1520 (0.0042) | 8.0 | No recognizable |
| | PEO solution² | sides a and b | | | difference |
| D | 5% by weight | Brushed | 0.1491 (0.0058) | 5.1 | Coated surface color |
| | PVA solution³ | sides a and b | | | slightly darker, no |
| | | | | | change in surface |
| | | | | | texture |
| E | Minway PA | Sprayed | 0.1552 (0.0044) | −11.2 | Coated surface color |
| | Spray⁴ | side a | | | slight darker, surface |
| | | | | | texture glossy and |
| | | | | | stiff |
| F | Latex solution⁵ | Brushed | 0.2018 (0.0118) | −57.8 | Coated surface |
| | | side a | | | texture appears |
| | | | | | glossy and wax-like |
| G | 5% by weight | Brushed | 0.1612 (0.0034) | 17.2 | No recognizable |
| | PEO solution⁶ | sides a and b | | | difference |

¹Polyox ™ N60K commercially available from Dow Chemical ®.
²Polyox ™ N60K commercially available from Dow Chemical ®.
³Airvol ™ polyvinyl alcohol commercially available from Air Products ®.
⁴Minway ® water-based polyacrylic protective finish spray, clear semi-gloss commercially available from Minway Company.
⁵Latex commercially available from Dow Reichold Specialty Latex, LLC.
⁶Polyox ™ N60K 5% having a gel-like consistency commercially available from Dow Chemical ®.
*The net coating thickness is an arithmetic value of the differences between the averages of the substrate thickness (B(1-3) − G(1-3)) and the reference group A(1-3).

### Tensile-Tear Break Tests of Samples A-G (Dry)

Each sample A(1-3)-G(1-3) was cut into strips measuring 5 in.×1 in. wide and a center having a width of 0.5 in. at the nexus of a pair of 45° dovetail cuts. FIG. 3 illustrates a representative sample shape and load direction of the stress being applied to each sample test strip. Three test strips were prepared for each sample group (i.e., Sample A1, A2, A3; Sample B1, B2, B3, etc.).

Each sample test strip was mounted in a Precision Vise 299-V-1 commercially available from Alltrade Professional. The lower portion of each sample test strip was clamped in the vise. The upper portion of each sample test strip was folded inwards 0.5 in. and secured by a piece of scotch tape, commercially available by the 3M Companies, to form a tube-like hanger portion for receiving a metal pin. A hand-held Compact Gauge 200N was connected to the metal pin and a force was applied in the direction of the vertical axis of each sample test strip until the sample test strip broke. The hand held Compact Gauge 200N is commercially available from Mecmesin Corporation, a registered Brown & Sharpe Inc. company, based in Horsham, United Kingdom and having distributors throughout the United States. The maximum force required to break the sample test strip was recorded. The results are presented in Table 2.

### Tensile-Tear Break Tests of Samples A-G (Wetted)

Another set of the sample test strips for Samples A-G were wetted by brushing water upon the coating layer near the center of each sample test strip over a time period of about two seconds. The wetted area was then covered with a piece of prefolded, water-saturated paper towel to maintain the wetness. Each sample test strip was wetted for 30 minutes at room temperature. The prefolded, water-saturated paper towel was removed, and each wetted sample test strip was mounted in a Precision Vise 299-V-1 commercially available from Alltrade Professional. The lower portion of each sample test strip was clamped in the vise. The upper portion of each sample test strip was folded inwards 0.5 in. and secured by a piece of scotch tape, commercially available by the 3M Companies, to form a tube-like hanger portion for receiving a metal pin. A hand-held Compact Gauge 200N was connected to the metal pin and a force was applied in the direction of the vertical axis of each sample test strip until the sample test strip broke. The maximum force required to break the sample test strip was recorded. The results are presented in Table 2.

TABLE 2

| Paper | | |
|---|---|---|
| Material | Average breaking force (dry) | Average breaking force (wet) |
| Codes | (standard deviation, lbs.) | (standard deviation, lbs.) |
| A | 14.16 (3.02) | 1.54 (0.67) |
| B | 15.86 (1.91) | 5.00 (1.27) |
| C | 15.87 (1.12) | 5.78 (1.87) |
| D | 17.24 (3.98) | 2.07 (0.87) |
| E | 16.11 (2.39) | 4.29 (2.64) |
| F | 17.38 (3.34) | 6.74 (2.12) |
| G | 17.82 (2.71) | 6.24 (1.60) |

### Results

From the results shown in Tables 1 and 2, one recognizes that when the substrate is coated with a layer of biodegradable polymer, the strength of the dry and wetted substrate are greater than the reference substrate. The coated substrates can maintain a greater tensile-tear strength as compared to the reference substrate.

The reinforcement of the substrate by the biodegradable polymer coating may be attributed to the minimization of the morphological irregularity and reduction of porosity of the surface of the substrate. Such improvements to the substrate surface mitigate microcrack propagation experienced by the substrate during stress bearing incidents. The biodegradable polymer coating also imparts water-repellant properties, similar to a varnish composition, that preserve the substrate.

The biodegradable polymer coatings and methods for applying the same of the present invention may be changed as necessary as will be recognized by one of ordinary skill in the art. For example, two or more biodegradable polymers may be utilized in a single coating or separated coatings to achieve the most beneficial synergistic effect, greatest wet strength and/or water-repellent properties. In another example, a combination of hydrophilic and hydrophobic polymers may be utilized to improve the wet strength and/or water-repellent properties of the paper. In addition, surfactants and/or suitable additives for odor controlling, compost promoting, coloring, stabilizing, and the like, may be included to modify the coating's properties and achieve other desirable substrate properties. The methods of application described herein may be changed as necessary as will be recognized by one of ordinary skill in the art. For example, the application process may also include dipping, pouring, hot-melt pressing, printing, jet spraying, combinations comprising at least one of the foregoing processes, and the like.

One or more embodiments of the present invention have been described. Nevertheless, it will be understood that various modifications may be made without departing from the spirit and scope of the invention. Accordingly, other embodiments are within the scope of the following claims.

What is claimed is:

1. A composite material, comprising:
at least one layer of fibrous material; and
at least one of biodegradable polymer layer comprising at least one biodegradable polymer, at least one biodegradable copolymer or both at least one biodegradable polymer and at least one biodegradable copolymer,
wherein said biodegradable polymer and said biodegradable copolymer each comprise a polymer block selected from the group consisting of poly(alkylene glycol), poly(alkylene oxide), poly(ethylene imine), polyalkylene, polyvinyl, polyvinylether, poly(vinylacetate), polyvinylpyrrolidine, polyester, polylactide, polyglycolide, polycaprolactone, poly(hydroxyalkanoate), poly(meth)acrylates, poly(acrylic acid) and salts thereof, polyether, polyurethane, poly(methacrylic acid) and salts thereof, polyacrylamide, polyepoxide, polyol, polysaccharides, and latex.

2. The composite material of claim 1, wherein said biodegradable polymer layer has a thickness of about 0.1 micron to 60 microns.

3. The composite material of claim 1, wherein said at least one layer of fibrous material comprises brown paper.

4. The composite material of claim 3, wherein said brown paper is grade A brown paper.

5. The composite material of claim 3, wherein said brown paper is grade B brown paper.

6. The composite material of claim 3, wherein said brown paper is grade C brown paper.

7. The composite material of claim 3, wherein said brown paper is grade D brown paper.

8. The composite material of claim 3, wherein said brown paper is grade E brown paper.

9. The composite material of claim 3, wherein said brown paper is grade F brown paper.

10. The composite material of claim 3, wherein said brown paper is grade G brown paper.

11. A process for manufacturing a composite material, comprising:
formulating an aqueous biodegradable solution having a polymer content of about 0.1% to 50% by weight of said solution, said biodegradable solution comprises at least one biodegradable polymer, at least one biodegradable copolymer or both at least one biodegradable polymer and at least one biodegradable copolymer;
applying said aqueous biodegradable solution to at least one surface of a fibrous material to form at least one biodegradable polymer layer; and
drying said at least one biodegradable polymer layer.

12. The process of claim 11, wherein said at least one biodegradable polymer and said at least one biodegradable copolymer each comprise a polymer block selected from the group consisting of poly(alkylene glycol), poly(alkylene oxide), poly(ethylene imine), polyalkylene, polyvinyl, polyvinylether, poly(vinylacetate), polyvinylpyrrolidine, polyester, polylactide, polyglycolide, polycaprolactone, poly(hydroxyalkanoate), poly(meth)acrylates, poly(acrylic acid) and salts thereof, polyether, polyurethane, poly(methacrylic acid) and salts thereof, polyacrylamide, polyepoxide, polyol, polysaccharides, and latex.

13. The process of claim 11, wherein the formulation step comprises formulating a substantially gel-like biodegradable solution.

14. The process of claim 11, wherein said application step comprises brushing a quantity of said aqueous biodegradable solution upon said at least one surface.

15. The process of claim 11, wherein said application step comprises brushing a quantity of said aqueous biodegradable solution upon said at least one surface sufficient to form said at least one biodegradable polymer layer having a thickness of about 0.1 micron to 60 microns.

16. The process of claim 11, wherein said application step comprises spraying a quantity of said aqueous biodegradable solution upon said at least one surface sufficient to form said at least one biodegradable polymer layer having a thickness of about 0.1 micron to 60 microns.

17. The process of claim 11, wherein said application step comprises applying a quantity of said aqueous biodegradable solution upon said at least one surface sufficient to form said at least one biodegradable polymer layer having a thickness equal to a thickness of said fibrous material.

18. The process of claim 11, wherein the drying step comprises drying said at least one biodegradable polymer layer at room temperature.

19. The process of claim 11, wherein the drying step comprises applying heat at a temperature sufficient to dry said at least one biodegradable polymer layer.

20. The process of claim 11, further comprising applying said aqueous biodegradable solution to at least one other surface of said fibrous material to form a second biodegradable polymer layer.

21. The process of claim 20, further comprising drying said second biodegradable polymer layer.
